(19) United States
(12) Patent Application Publication
(10) Pub. No.: US 2005/0233063 A1
(43) Pub. Date: Oct. 20, 2005

(54) Coating operation pollutant emission measurement and recording system and method

(76) Inventors: Jeff L. Weiler, Cypress, TX (US); Dave Dooley, Hillsboro, OR (US)

Correspondence Address: KENNETH L. NASH, P.O. BOX 680106, HOUSTON, TX, 77268-0106, US

(21) Appl. No.: 10/825,347

(22) Filed: Apr. 15, 2004

(51) Int. Cl. B05D 7/00

(52) U.S. Cl. 427/8; 427/421.1

(57) ABSTRACT

Systems and methods are provided for measuring volatile organic compound (VOC) and hazardous air pollutant (HAP) emissions from coating operations. The system may also be used to assist the user for demonstration of compliance with Environmental Protection Agency (EPA) and State regulations. In one embodiment, the system comprises programmable processor(s) preferably electronically connected to digital scale(s), interface, and a product flow controller. Software is utilized to document changes in product weights as the coatings are applied to a selected object which may typically be positioned in a ventilated spray booth. The emissions may preferably be calculated based on material balance of the amount of the product used, product density, and pollutant content within the specified product as per EPA requirements or by other means preferably approved by the EPA or any selected specific State.

### TECHNICAL FIELD

The present invention relates generally to emission measurement and, more specifically, to systems and methods for measuring product usage and pollutant emissions from coating operations.

### BACKGROUND

The U.S. Environmental Protection Agency has indicated in Emission Inventory Improvement Program (EIIP) documents that the choice of methods to be used to estimate emissions depends on how the estimates will be used and the degree of accuracy required. Volume II, Chapter 7 of the Emission Inventory Improvement Program entitled “Preferred and Alternative Methods for Estimating Air Emissions from Surface Coating Operations,” Jul. 1, 2001, prepared by Eastern Research Group, Inc. for Point Sources Committee, provides a general overview of guidelines, terminology, and presently available methods for emission inventory methods.

Spray booths are often utilized by many companies for applying coatings such as primers, topcoats, paint coatings, solvents, and the like, which may comprise a wide variety of coating formulations. A non-limiting listing of typical coatings as used herein may comprise epoxies, epoxy/acrylics, acrylics, polyesters, enamels, solvents, cleaning agents, and the like. Liquid coatings may comprise organic solvents or water as the main carrier for paint solids and/or solvents for cleaning the lines after use and/or other solvents. The spray booths may typically comprise a ventilation hood or exhaust stack through which uncaptured emissions are vented to the environment. It is necessary to provide means for estimating an inventory for pollutants that have been emitted. As a non-limiting example, such pollutants may comprise volatile organic compound (VOC) and hazardous air pollutant (HAP) emissions.

Currently, coating operation technology for record keeping of product usage at coating operations utilizes manual documentation on forms, such as those described in the aforementioned EIIP documents, which may lead to significant errors.

Consequently, there remains a need to provide an emission inventory record keeping system and method which is more accurate and more consistent and that can also be used to assist the user in compliance demonstration. It would be desirable to provide a system which can be used by any company, for any type of product usage, and which eliminates the errors involved in human interaction of entering data onto forms. Moreover, it would be desirable to provide an automated inventory record keeping system and method which eliminates many of the errors that can typically arise. Those of skill in the art will appreciate the present invention which addresses the above and other problems.

### SUMMARY OF THE INVENTION

One possible objective of the present invention is to provide an improved emission inventory system.

Another possible objective of the present invention is to provide a more accurate emission inventory system.

Yet another possible objective of the present invention is to provide an automated emission inventory system which more reliably inventories product usage and emissions.

Yet another possible objective of the present invention is to provide a computer controlled measurement system and emission calculation and inventory system.

These and other objectives, features, and advantages of the present invention will become apparent from the drawings, the descriptions given herein, and the appended claims. However, it will be understood that above-listed objectives and/or advantages and/or features of the invention are intended only as an aid in understanding certain aspects of the invention, are not intended to limit the invention in any way, are not intended to provide limiting language outside of the claim language which more accurately provides a description of the claimed invention and variations thereof, and do not form either a comprehensive or a restrictive list of objectives, and/or features, and/or advantages.

Accordingly, the present invention provides an emission inventory system for use in a coating operation for application of a coating material. One or more containers are provided for storing the coating material prior to and/or during the application of the coating material. In one embodiment, the system may comprise a coating material measurement assembly for measuring at least one physical phenomenon related to an amount of the one or more coating materials utilized during the coating operation, one or more storage containers for the one or more coating materials, a flow control mechanism, an interface for entering coating material data relating to a selection of the one or more coating materials for the coating operation, and/or one or more processors operable with the coating material, the flow control measurement assembly, the flow control mechanism, and the interface.

In another embodiment, the emission inventory system may comprise one or more elements such as, for instance, a preferably programmable digital flow control mechanism operable for determining when the coating material measurement assembly is ready for measuring the at least one physcial phenomena. The programmable digital flow control mechanism is also preferably operable for controlling the application of the coating material to permit the coating operation to proceed when the coating material measurement assembly is ready for measuring the physical phenomena. The programmable digital flow control mechanism is preferably operable for automatically preventing the application of the coating material from proceeding until the coating material measurement assembly is ready for measuring the physical phenomena related to the amount of coating material utilized during the coating operation.

In another possible embodiment, the programmable digital flow control mechanism is responsive to at least a selected positioning and/or weight of the one or more containers for determining when the coating material measurement assembly is ready or not ready. The emission inventory system may further comprise an interface for entering coating material data comprising information concerning the coating material. The emission inventory system may be responsive to the interface and the data entered therein for determining when the coating material measurement assembly is ready for measuring the at least one physical phenomena related to the amount of coating material utilized during the coating operation. In one preferred embodiment, the coating material measurement assembly comprises a digital scale with the digital scale being operable for determining a relative change in weight of the one or more containers during the coating operation which is related to the amount of coating material utilized during the coating operation.

The emission inventory system may further comprise one or more processors responsive to the coating material data from the interface and the coating material measurement assembly for providing reports of coating material usage. In one preferred embodiment, the emission inventory system may further comprise one or more processors responsive to the coating material data from the interface and the coating material measurement assembly for generating reports of emissions produced by the coating operation with respect to selective time intervals. The emission inventory system may further comprise one or more processors operable for providing EPA approved report formats.

In one preferred embodiment, the emission inventory system may further comprise at least one sprayer, a flow passageway in fluid communication with the at least one sprayer, the programmable digital flow control mechanism comprising one or more valves to either permit or prevent fluid flow to the at least one sprayer.

In operation, a method is provided for inventorying of emissions from coating operations which may comprise one or more steps such as putting one or more coating materials into one or more containers, providing one or more spray tip flow lines from the one or more containers to at least one spray tip within at least one spray booth and/or application area, entering identification information for the coating materials with one or more electronic input devices, and/or activating one or more flows of the coating materials to the spray tip through the spray tip flow lines. Other steps may comprise electronically monitoring the flows of the coating materials to the spray tip through the spray tip flow lines, selectively stopping the flow of coating material to the spray tip, and/or providing one or more processors programmed for collecting computer data during the flow of the one or more coating materials and for storing computer data related to one or more time intervals, and the identification information for the one or more coating materials, and a respective amount of the one or more coating materials utilized. The method may further comprise electronically generating at least one of a material usage report or an emission report based on the computer data collected. As well, the method may comprise providing one or more sensors for electronically monitoring the flow of coating material to the spray tip through the spray tip flow lines and/or determining whether the one or more sensors are ready. If the sensor is not ready, then the method may comprise automatically preventing the activation and/or automatically stopping the flow of the coating material.

This summary is not intended to be a limitation with respect to the features of the invention as claimed, and this and other objects can be more readily observed and understood in the detailed description of the preferred embodiment and in the claims.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a perspective view showing one embodiment of a digital scale controller for use in a coating operation emission inventory comprising an interface for entering information regarding the coating and automatically operating one or more valve-controlled paint/air outlets in accord with one possible embodiment of the present invention;

FIG. 2 is a schematic of an overall coating operation with automatic inventory control system and method in accord with the present invention; and

FIG. 3 is a schematic of one possible interface display for use with an inventory control system control in accord with the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention.

### GENERAL DESCRIPTION OF PREFERRED EMBODIMENTS FOR CARRYING OUT THE INVENTION

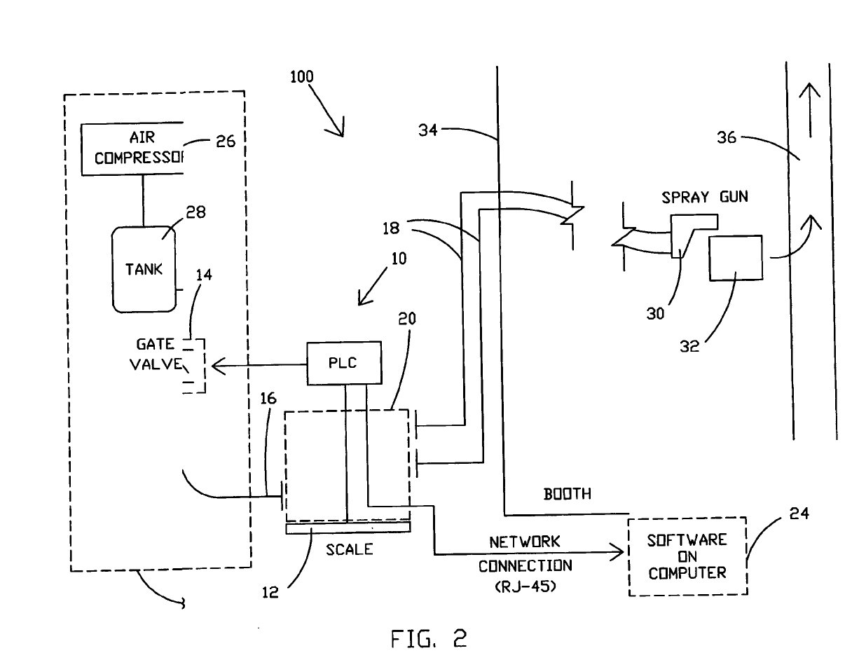

Many manufacturing companies utilize coating operations to apply seal coats, performance-based coatings, or top coats. Any company that has a spray booth or some other type of coating operation can use the present system to measure the weight, volume, and/or other coating material parameters as discussed hereinafter in order to determine VOC and HAP emissions. If desired, booth manufacturers can package the system of the present invention with the booth to assist the purchaser in record keeping activities from the start of operations. Booth 34 (shown in FIG. 2) is intended to be schematically representative of any type of booth for purposes of illustrating operation of the present invention. As used herein an application area may comprise a spray booth which is closed off and ventilated, a curtained area, a general area for spraying, an outdoors area for spraying, or any other area wherein coating operations are utilized and where it is desired to inventory the coating and/or emissions.

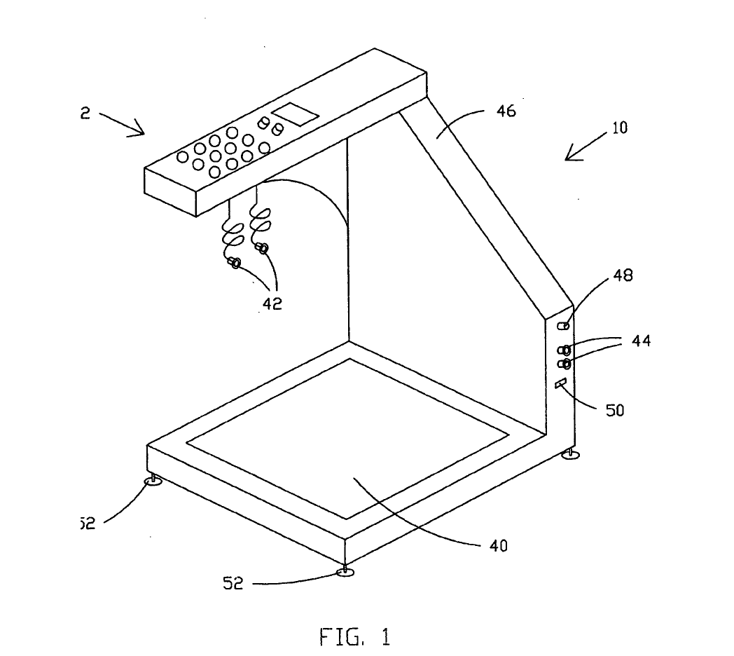

Referring now to the drawings and, more particularly to FIG. 1 and FIG. 2 there are shown possible embodiments of a coating operation controller 10 (see FIG. 1) which may be utilized within a coating operation system 100 (see FIG. 2).

In the system embodiment as shown in FIG. 2, controller 10 may comprise digital scale 12, flow valve 14, and suitable connectors for input line(s) 16 and output line(s) 18 that may be utilized to fluidly interconnect container or canister 20 for the application of various coatings or solvents to any desired object 32. Application system or process 100 may have a “spray pot,” canister, or container 20 that contains the coating to be applied. The “pot” may be attached to a spray gun, such as spray gun 30, by one or more hose lines 18 which may comprise any combination or type of liquid and/or compressed air lines. The coating material and air may enter the gun through separate passages, such as lines 18, and can be mixed and discharged through an air nozzle, providing a controlled spray pattern. Object 32 may be any object which is coated within booth 34. Booth 34 may preferably be pressure ventilated through ventilation vent 36 to the atmosphere, filtering means, or other desired output.

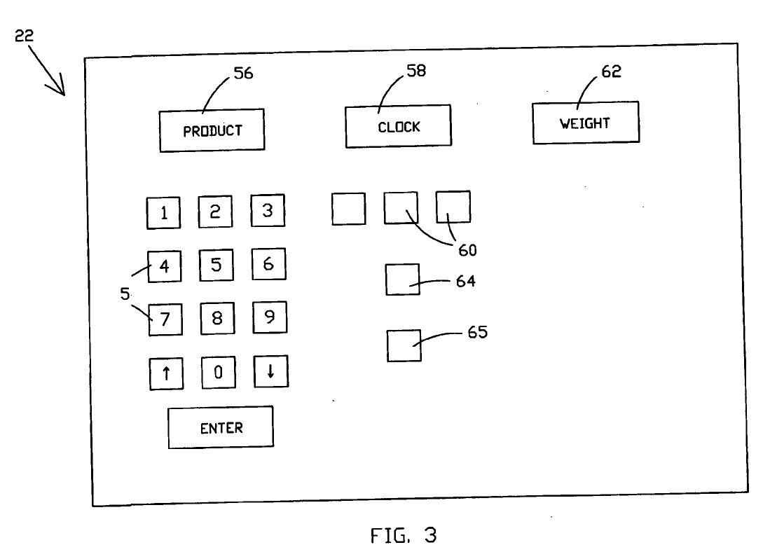

Interface 22 (see FIG. 1) on controller 10 may be used to select any number of coating products to be applied during any stage of a coating process as desired such as from a list, product numbers, or the like. An example of a possible layout for interface 22 is shown in FIG. 3. Interface 22 may comprise any means to select products such as keyboard, mouse, bar code scanner, switch or button system, or the like. Controller 10 and/or other processors may be utilized to monitor the precise amount of time of the coating application process for exact and automatic inventory calculations with less likelihood of human error. Controller 10 may be utilized to transmit this data to the inventory software on computer 24 (see FIG. 2). Alternatively, product information may be input utilizing the inventory software on computer 24 or other suitable input means. The inventory software on computer 24 or other processing means may be programmed in accord with EPA specifications to request data and to make calculations to produce the most highly accurate emission inventories. It is believed that the record keeping and/or continuous monitoring of present invention is the best available system for these functions and in one form or another may eventually become designated as an element of best available emission inventory control technology (BACT).

In a particular embodiment for use with compressed air coating material delivery systems, controller 10 operates a gate valve or other type of valve 14 to thereby either permit or prevent the flow of compressed air from air compressor 26 and/or compressed air tank 28 to one or more spray gun(s), nozzle(s), or tip(s) 30. More generally, unit 38 may be any type of mechanism for delivering the coating. Some other types of delivery systems are mentioned briefly hereinafter as examples.

Preferably, the coating operation will be permitted to continue only when input and output lines 16 and 18 are connected and container 20 is properly positioned on scale 12. For instance, controller 10 may be programmed to sense the weight or the absence of container 20. Scale 12 is then able to continuously monitor the weight of the coating. By knowing the weight of material utilized, type of coating, and/or other parameters such as temperature, ventilation flow, the amount of coating material and the emissions produced can be precisely monitored. Moreover, because controller 10 is preferably programmed so that the coating operation is permitted to proceed only when container 20 is properly positioned on scale 12 so that scale 12 is able to weigh all the coating materials utilized, errors due to measurements, forgetfulness, and the like, are eliminated. All coating material is necessarily measured as used. In one practical but non-limiting embodiment, scale 12 may, for instance, have a capacity up to 200 lbs. and an accuracy of 0.1 lbs. The difference in weight from the beginning of the coating operation to the end of the coating operation provides an accurate determination of the amount of coating material utilized. The weight may be continuously and/or relatively continuously monitored and/or sampled at any suitable data sampling rates to determine coating flow rates as desired. The time of the operation may be utilized to determine average coating flow rates or for other inventory purposes as desired. In one embodiment, time, weight, coating type data from controller 10 may be utilized by software, such as software in computer 24, to thereby store a variety of information including the date and time of the start and end of the application process, weight of the product being used at the start and end of the application process, and type of product applied. Time elapsed during the application process can be transmitted as an additional parameter. This information, may be utilized to automatically generate reports concerning product usage and emission inventories.

Various types of sensors may be utilized to indicate that controller 10 is ready to monitor coating material utilized. For instance, one or more position sensors, pressure sensors, optical sensors, acoustic sensors, microwave sensors, and the like may be utilized. As discussed above, a low cost and simple embodiment utilizes digital scale 12 both to sense that container 20 is in place as well as to monitor product usage. Once container 20 is positioned on and connected with controller 10 so that controller 10 is ready to monitor product usage, then controller 10 is preferably programmed to operate valve 14 to permit the coating operation to proceed. If container 20 is not positioned on controller 10, or otherwise not connected to controller 10 in a manner whereby controller 10 is able to monitor usage of the coating material, then valve 14 is closed to prevent the coating operation from proceeding.

While a preferred embodiment of controller 10 utilizes digital scale 12 to measure the amount of coating material utilized, other measurement means may also be utilized. Thus, controller 10 may comprise a coating material measurement assembly for measuring at least one physical phenomenon related to an amount of said coating material utilized during said coating operation. For instance, the amount and/or volume of coating material in canister or container 20 may be determined by acoustic sensors, level indicators, microwave sensors, pressure sensors, contact sensors, capacitive sensors, and/or any other suitable types of sensors. If airless coating systems are utilized for coating flow delivery means 38 instead of compressed air, then piston movement sensors, pressure indicators, or the like may be utilized to measure the volume and flow rates of coating materials. Moreover, various types of suitable flow meters which may comprise Doppler measurement sensor groups, microwave sensors, acoustic sensors, pressure sensors, mechanical measurement sensors, combinations of the above, or any other type of flow sensors may be utilized, if desired. Moreover, combinations of the above sensors or selective sensitive or variable groups of sensors may be utilized for monitoring the amount of coating material.

Thus, control 10, or computer 24, and/or one or more other processors effectively provide a programmable flow control mechanism operable for determining when the coating material measurement assembly, such as scale 12 or other measurement means, is ready for measuring at least one physcial phenomena related to the amount of coating material utilized during the coating operation such as weight, volume, level, flow rate, or the like. Accordingly controller 10, computer 24, and/or other processors are therefore operable for controlling the coating operation process including the flow of coating material to thereby permit the coating operation to proceed when scale 12 or other coating material measurement assembly is ready for measuring at least one physical phenomena related to the amount of coating material utilized during the coating operation.

FIG. 1 shows a specific embodiment of controller 10 that may be readily utilized in a wide variety of coating operations. Scale surface 40 (FIG. 2) may comprise a digital scale bed on which the canister or container 20 for the coating material is placed. Scale surface 40 in FIG. 1 provides a suitable surface or receptacle for digital scale 12 (shown in FIG. 2). Hoses 42 may comprise one or more hoses for connection to container 20 such as, for example only, the air supply for connection to container 20 (e.g. from line 16 shown in FIG. 2), and the paint/air lines out of container 20 (e.g. from lines 18 shown in FIG. 2). Thus, while two hose connections 42 are shown in FIG. 1, it will be understood that any number of hose connections to the container(s) may be utilized. Any number of outlet connections 44 may be utilized to connect to the sprayer, applicator, air guns or the like (e.g. lines 16 lines 18 shown in FIG. 2). Valve 14 (shown in FIG. 2) may be built into frame 46 of controller 10, if desired. Thus, input hoses 42, output connections 44, and valve 14 may comprise an easily mountable and compact specific construction or embodiment of elements 10, 14, 16, and 18 of the more generalized system 100 as illustrated in FIG. 2. Switch connection 48 may be used to operate controller 10 utilizing the spray gun or other applicator means for controlling the flow of coating material. Connector 50 may be utilized to connect to a computer such as computer 24 shown in FIG. 2. Leveling feet 52 may be adjusted such as by rotation or the like to level scale bed 40.

FIG. 3 shows a sample display 22 which may be utilized in controller 10. The display is useful in operating controller 10 in an application process to ultimately determine air quality emissions from the coating process. Input keys 54 may be utilized to select various coating products as may be shown in product ID or type display 56. Clock display 58 may be utilized to show the date and time. Controls 60 may be utilized to set the time and/or date. Weight display 62 may be utilized to show the current weight and/or flow rate and/or change of weight in a selected time period, average flow or product usage, and/or other information as desired. Start/stop keys 64 and 65 may be utilized to start and end operation. For instance, after pressing start key 64, then spraying may start. Alternatively, spraying may then be controlled to start utilizing a spray gun by an operator in spray booth 34.

System 100 and controller 10 is very suitable for High Volume/Low Pressure (HVLP) spray gun coating application operations. With these spray systems, low pressure is used with large volumes of air to atomize coatings. The air source for an HVLP system can be conventional compressed air and/or a turbine such as air compressor 26 and tank 28. HVLP systems are designed to reduce VOC emissions and are therefore some of the most widely used devices. The present invention may also be utilized for Low Volume/Low Pressure (LVLP) systems which are similar to HVLP system but wherein less air pressure is used. The present invention may also be utilized by other conventional pressure-type applications. For instance, compressed air may be applied to the “pot” and the coating material is pushed through the hose and out of the spray nozzle 32. Pressure-type systems are normally used when large amounts of material are required and/or when the material is too heavy to be siphoned from a container, or when fast application is required.

The present invention may also be utilized for airless spray systems wherein hydraulic pressure alone is used to atomize the fluid at high pressure through a small orifice in the spray nozzle. Upon exiting the spray nozzle at high pressure, the fluid breaks up into fine droplets resulting in a fine atomized spray. As a result no compressed air is needed.

The software program utilized in computer 24 can archive the data for future reference. The program also stores all of the pertinent product and manufacturer information necessary to calculate VOC and HAP emissions to the atmosphere. The data stored can also be accessed to estimate particulate emissions from the coating operations. Pollutant emissions are calculated from the weights of the various products using a material balance technique. Reports can be generated on any time interval basis. That is, the user can specify the date/time range to generate a report or the user can select a predetermined time interval such as monthly or annual.

In operation of the present invention, data fields relating to the date, time, product used, and weight of the product, are entered either by controller 10 and/or computer 24. Once start button 64 is pressed, control system 10 activates flow control valve 14 to supply compressed air for use by the application system. Product may flow automatically or be controlled by an operator utilizing spray gun 30. Once end button 65 is pressed, control 10 will shut off the flow of compressed air from tank 28 so that product flow can no longer occur.

The process may comprise steps such as placing product canister 20 on scale 12 where its presence is sensed by one or more means. Air supply lines 16 and/or spray gun lines 18 are attached with respect to canister 20. The product ID is entered and start button 64 is pressed. Controller 10 transmits date/time, product ID, weight and/or other parameters, and the like into computer 24. Controller 10 activates valve 14 to permit compressed air to flow or other motive force means to force the coating process to flow. Once, the application or cleaning process is completed, then stop button 65 is selected. Controller 10 then stops the motive force, such as compressed air, by closing valve 14. Data related to date/time, product ID, weight and/or other parameters, and other info such as ID related to controller 10 is transferred to computer 24. The air supply is detached from canister 20. Canister 20 may then be removed from scale 12. Data is stored in the computer program to calculate VOC and/or HAP generated from the coating or solvent application process. Other coatings may be subsequently applied utilizing the above process such as other paints, solvents, and/or cleaners.

The foregoing disclosure and description of the invention is therefore illustrative and explanatory of one or more presently preferred embodiments of the invention and variations thereof, and it will be appreciated by those skilled in the art that various changes in the design, organization, order of operation, means of operation, equipment structures and location, methodology, and use of mechanical equivalents, as well as in the details of the illustrated construction or combinations of features of the various elements, may be made without departing from the spirit of the invention. As well, the drawings are intended to describe the concepts of the invention so that the presently preferred embodiments of the invention will be plainly disclosed to one of skill in the art but are not intended to be manufacturing-level drawings or renditions of final products and may include simplified conceptual views as desired for easier and quicker understanding or explanation of the invention. It will be seen that various changes and alternatives may be used that are contained within the spirit of the invention. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1. An emission inventory system for use in a coating operation for application of a coating material within an application area during said coating operation, one or more containers for storing said coating material prior to said application of said coating material, emissions being produced during said application of said coating material, said emission inventory system comprising:
a coating material measurement assembly for measuring at least one physical phenomenon related to an amount of said coating material utilized during said coating operation; and
a control mechanism operable for determining when said coating material measurement assembly is ready for measuring said at least one physcial phenomenon related to said amount of coating material utilized during said coating operation, said control mechanism being operable for controlling said application of said coating material to permit said coating operation to proceed when said coating material measurement assembly is ready for measuring said at least one physical phenomenon related to said amount of coating material utilized during said coating operation, said control mechanism being operable for automatically preventing said application of said coating material from proceeding until said coating material measurement assembly is ready for measuring said at least one physical phenomenon related to said amount of coating material utilized during said coating operation.

2. The emission inventory system of claim 1 wherein said control mechanism is responsive to at least a selected positioning of said one or more containers for determining when said coating material measurement assembly is ready or not ready for measuring said at least one physical phenomenon related to said amount of coating material utilized during said coating operation.

3. The emission inventory system of claim 1 further comprising an interface for entering coating material data comprising information concerning said coating material.

4. The emission inventory system of claim 3 wherein said control mechanism is responsive to said interface for determining when said coating material measurement assembly is ready for measuring said at least one physical phenomenon related to said amount of coating material utilized during said coating operation.

5. The emission inventory system of claim 3 wherein said coating material measurement assembly comprises a scale, said scale being operable for determining a change of weight of said coating material within said one or more containers during said coating operation which is related to amount of coating material utilized during said coating operation.

6. The emission inventory system of claim 3 further comprising one or more processors responsive to said coating material data from said interface and said coating material measurement assembly for providing reports of coating material usage.

7. The emission inventory system of claim 3 further comprising one or more processors responsive to said coating material data from said interface and said coating material measurement assembly for providing reports of emissions produced by said coating operation with respect to selective time intervals.

8. The emission inventory system of claim 1 further comprising one or more processors operable for providing EPA reports.

9. The emission inventory system of claim 1 further comprising at least one sprayer, a flow passageway in fluid communication with said at least one sprayer, said control mechanism comprising one or more valves to either permit or prevent fluid flow to said at least one sprayer.

10. An emission inventory system for use in a coating operation, at least one applicator for applying one or more coating materials within a application area during said coating operation, one or more containers for storing said one or more coating materials prior to said applying of said one or more coating materials, emissions being produced during said applying of said coating material, said emission inventory system comprising:
a coating material measurement assembly for measuring at least one physical phenomenon related to an amount of said one or more coating materials utilized during said coating operation;
a flow control mechanism;
an interface for entering coating material data relating to a selection of said one or more coating materials for said coating operation; and
one or more processors operable with said coating material said flow control measurement assembly, said flow control mechanism, and said interface.

11. The emission inventory system of claim 10 wherein said one or more processors is programmed to control flow of said one or coating materials to said one or more applicators.

12. The emission inventory system of claim 10 wherein said one or more processors is programmed for monitoring the amount of time of said flow of said one or more coating materials.

13. The emission inventory system of claim 10, further comprising a compressed air source, an input flow line to said one or more containers, and one or more flow lines to said at least one applicator, said flow control mechanism comprising one or valves controlled by said one or more processors.

14. The emission inventory system of claim 10 wherein said one or more processors is programmed for recording data related to said flow control measurement assembly, said flow control mechanism, and said interface for producing reports of pollutant emissions on a time interval basis.

15. A method for providing an inventory of emissions from coating operations, comprising:
providing one or more coating materials into one or more containers;
providing one or more spray tip flow lines from said one or more containers to at least one spray tip within at least one spray area;
entering identification information for said one or more coating materials with one or more electronic input devices;
activating one or more flows of said one or more coating materials to said at least one spray tip through said one or more spray tip flow lines;
monitoring said one or more flows of said one or more coating materials to said at least one spray tip through said one or more spray tip flow lines;
stopping said one or more flows of said one or more coating materials to said at least one spray tip; and
providing one or more processors programmed for collecting computer data during said one or more flows of said one or more coating materials and for storing computer data related to one or more time intervals of said one or more flows of said one or more coating materials, and said identification information for said one or more coating materials, and a respective amount of said one or more coating materials utilized.

16. The method of claim 15, further comprising electronically generating at least one of a material usage report or an emission report based on said computer data.

17. The method of claim 15, further comprising providing one or more sensors for said electronically monitoring said one or more flows of said one or more coating materials to said at least one spray tip through said one or more spray tip flow lines, determining whether said one or more sensors are ready for said step of electronically monitoring said one or more flows of said one or more coating materials to said at least one spray tip through said one or more spray tip flow lines, and if said one or more sensors are not ready then automatically preventing said activation or automatically stopping said one or more flows of said one or more coating materials to said at least one spray tip through said one or more spray tip flow lines.

18. The method of claim 15, further comprising monitoring a weight of said one or more containers.

19. The method of claim 15 further comprising programming said one or more processors to calculate at least one of volatile organic compounds or hazardous air pollutant emissions over a selected period of time.

20. The method of claim 15 wherein said step of electronically monitoring said one or more flows of said one or more coating materials to said at least one spray tip through said one or more spray tip flow lines further comprises monitoring a weight of said one or more containers.
